(19) United States
(12) Patent Application Publication
(10) Pub. No.: US 2013/0173486 A1
(43) Pub. Date: Jul. 4, 2013

(54) COLLABORATION CLOUD

(71) Applicants: Johan Christiaan Peters, Sankt Leon-Rot (DE); Vera Legisa, Karlsruhe (DE); Udo Arend, Heidelberg (DE); Sabine Finke, Karlsruhe (DE); Rainer Matthias, Berlin (DE)

(72) Inventors: Johan Christiaan Peters, Sankt Leon-Rot (DE); Vera Legisa, Karlsruhe (DE); Udo Arend, Heidelberg (DE); Sabine Finke, Karlsruhe (DE); Rainer Matthias, Berlin (DE)

(73) Assignee: SAP AG, Walldorf (DE)

(21) Appl. No.: 13/340,427

(22) Filed: Dec. 29, 2011

(51) Int. Cl. G06Q 10/00

(52) U.S. Cl. 705/319

(57) ABSTRACT

A collaboration cloud system generates a business task and identifies participants of the business task, a process of the business task, communications among participants, and documents and objects associated with the business task. A collaborative display for the business task is generated for the participants to collaborate on the business task. The collaborative display identifies the participants of the business task, the process of the business task, the communications among participants, and the documents and objects associated with the business task.

### FIELD

The present disclosure relates generally to a business collaboration tool, and in a specific example embodiment, to a collaboration cloud.

### BACKGROUND

Business processes, such as the process of hiring an employee, may require numerous steps from various personnel of an organization. For example, a manager emails his/her superior to obtain approval to hire more personnel for a job specification. Upon approval, the manager emails the job specification to an employee of a human resource (HR) department of the organization. The HR department then posts the job specification and receives resumes from applicants. Various individuals of the organizations then interview the applicants. Emails may be exchanged back and forth between the interviewers and the HR department to provide feedback, approval, and to further the process of hiring an applicant. As such, many individuals that participate in a business process consume a lot of their time retrieving emails and documents from various applications that may reside in different locations.

### BRIEF DESCRIPTION OF DRAWINGS

The appended drawings merely illustrate example embodiments of the present invention and cannot be considered as limiting its scope.

FIG. 1 is a block diagram illustrating an example of a system in which embodiments may be practiced.

FIG. 2 is a block diagram illustrating a collaboration cloud application, in accordance with an example embodiment.

FIG. 3 is a block diagram illustrating an example embodiment of a user interface of the collaboration cloud application.

FIG. 4 is a block diagram illustrating another example embodiment of a user interface of the collaboration cloud application.

FIG. 5 is a block diagram illustrating another example embodiment of a user interface of a participants and communication area of the collaboration cloud application.

FIG. 6 is a block diagram illustrating another example embodiment of a business process area of a user interface of the collaboration cloud application.

FIG. 7 is a block diagram illustrating another example embodiment of an object area of a user interface of the collaboration cloud application.

FIG. 8 is a flowchart of a method, in accordance with an example embodiment, for generating a collaborative user interface of a business process.

FIG. 9 is a flowchart of a method, in accordance with an example embodiment, for making use of a collaborative user interface of a business process.

FIG. 10 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

Example systems and methods to collaborate on a business task are described. In one example embodiment, a collaboration cloud system generates a business task and identifies participants of the business task, a process of the business task, communications among participants, and documents and objects associated with the business task. A collaborative display for the business task is generated for the participants to collaborate on the business task. The collaborative display identifies the participants of the business task, the process of the business task, the communications among participants, and the documents and objects associated with the business task.

In one example embodiment, the collaborative display is generated based on participants identified in the business task, a status of the process of the business task, communications among participants, updated documents and objects associated with the business task. The objects may include a document, an image, an application, a contact, a meeting schedule, a web site, or a note.

In one example embodiment, a template associated with the business task is determined. The process of the business task is then generated based on the template.

In one example embodiment, a user interface is generated. The user interface may include a first section to identify the business task, a second section to identify participants of the business task, a third section to display communications between participants of the business task, a fourth section to provide the process of the business task, and a fifth section to provide documents and objects associated with the business task.

In another example embodiment, messages associated with the business task are filtered from an inbox email of a participant. The filtered messages and other communications related to the business task are integrated in the third section of the user interface.

In another example embodiment, the fourth section of the user interface includes a status of the process of the business task, completed steps of the process of the business task in the fourth section of the user interface, remaining steps of the process of the business task in the fourth section of the user interface, and participants associated with the status, and the completed steps and the remaining steps of the process of the business task.

In another example embodiment, the fifth section of the user interface includes a thumbnail view of the objects and documents associated with the business task in the fifth section based on a status of the process of the business task. Each thumbnail view of each object or document is associated with a corresponding application.

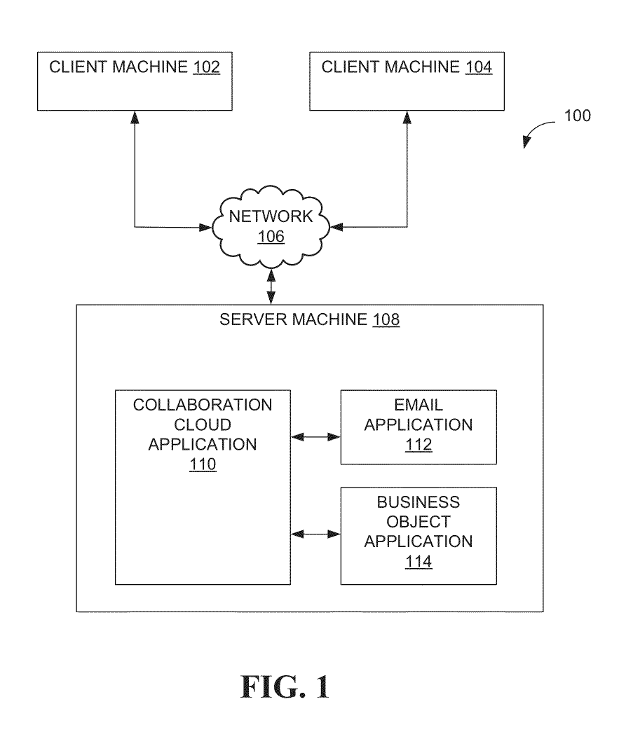

FIG. 1 is a block diagram depicting an example environment 100 within which example embodiments may be deployed. The environment 100 includes one or more client machines (e.g., client machines 102, 104). For example, the client machines 102, 104 may be a personal computer, or a mobile computing device of participants of a business task.

In one embodiment, the client machine 102 may be used to access elements or processes of the business task. For example, a user interface may be provided for the participants to collaborate on the business task. The client machine 102 may execute a web browser (not shown) or a software application (not shown). For example, the web browser may be any browser commonly used to access a network of computers such as the World Wide Web. The web browser may load a user interface to collaborate on the business task. In another embodiment, the software application may load a user interface to collaborate on the business task. In another embodiment, the web browser or the software application may display a visual representation of the business process in the user interface.

The environment 100 includes a server machine 108. The server machine 108 executes one or more application (e.g., collaboration cloud application 110, email application 112, business object application 114.

The business object application 114 defines the process of a business task. For example, various participants need to perform several steps in the process of hiring an employee. A manager may request a job requisition for approval from a superior. In one embodiment, the business object application 114 may process a business task with business objects. For example, a business object may correspond to one or more entities within the business object application 114 that represent things in a business to which the business object application 114 pertains. For example, the business object may map a source data structure in a database to business terms used by non-Information Technology analysts. The business object may also correspond to a function of the database or the business object application 109. For example, if the business object application 109 is a Human Resources application pertaining to recruiting of candidates for job openings within a company, the business object may correspond to a person (e.g., a job candidate) who has applied for a job opening. The business object may include one or more data items. The data items of the business object may correspond to any data that one or more additional applications maintain with respect to the business object. For example, the data item may be a resume of a person (e.g., a candidate for an open position at a company) represented by the business object or the data item may be a time card of a person (e.g., an employee of a company) represented by the business object.

In one embodiment, the email application 112 may be configured to enable the participants of the business task to communicate with each other and others. The email application 112 may include a convention email server application.

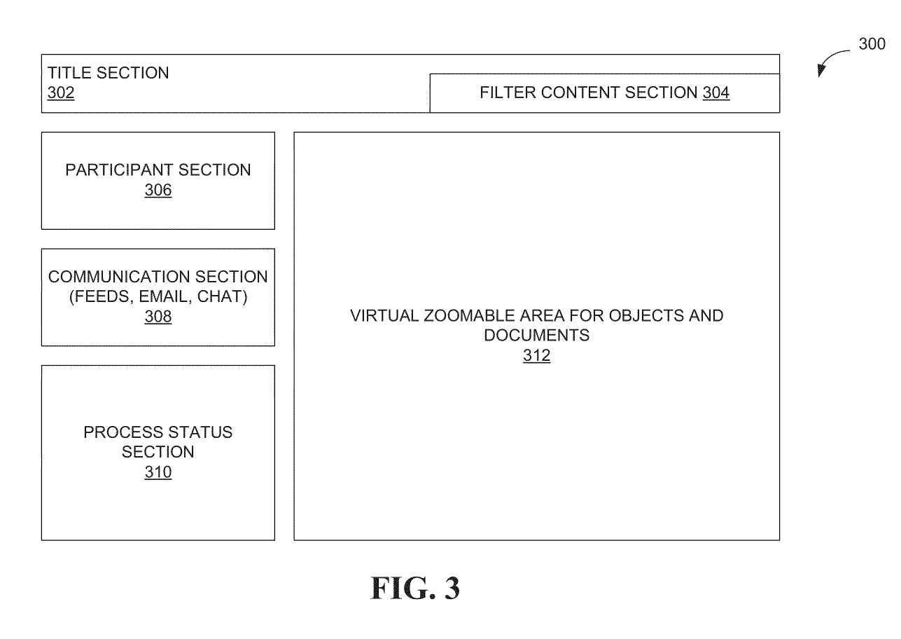

The collaborative cloud application 110 enables participant to collaborate on a business task by updating data from the email application 112 and the business object application 114, and presenting the aggregated in a single user interface dedicated to the business task. In other words, the collaborative application 110 allows to place things and people on it and to share it with others to support collective work. It provides a named container on the desktop to temporarily place things for one dedicated business task, and to integrate Feeds combined with an Inbox for the dedicated purpose of its usage. Additionally, a process advisor template can be instantiated within the collaboration cloud to guide users/participants through a business task. For example, a single user interface may be designed and associated with the business task of hiring an employee. The business process application may be configured to process business objects associated with the business task (e.g., hiring an employee). The user interface is described in more detail below with respect to FIG. 3.

The client machines 102, 104, and the server machine 108 may be coupled to each other via a network 106. The network 106 enables communication between systems. Accordingly, the network 106 may be a mobile telephone network, a Plain Old Telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 120 may be implemented using the Internet, a wide area network (WAN), a local area network (LAN), or any suitable combination thereof.

It should be noted that the user interface is generated at the server machine 108 and as such, can be accessible from any client machine.

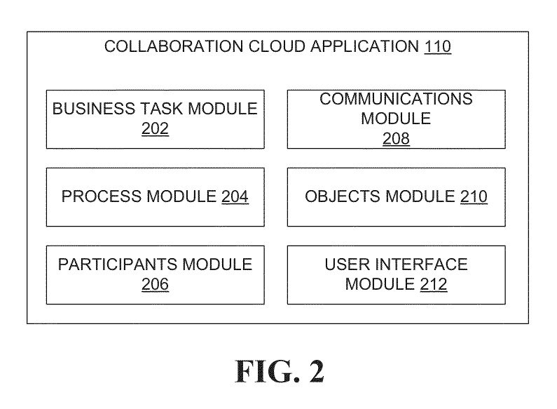

FIG. 2 is a block diagram illustrating the collaboration cloud application 110, in accordance with an example embodiment. The collaboration cloud application 110 may include a business task module 202, a process module 204, a participants module 206, a communications module 208, an objects module 210, and a user interface module 212.

The business task module 202 generates a business task (e.g., hiring an employee, generating a purchase order for a manufacturing component, and so forth). The business task may be generated by a user or retrieved from an existing library of business tasks.

The process module 204 determines a process of the business task. The business task involves several steps to be completed by identified participants of the business task. For example, if the business task is hiring an employee, the process includes receiving a job requisition request from a manager, getting approval from a superior, posting the job requisition, receiving resumes and emails in response to the job posting, selecting candidates for interview, scheduling interviewers associated with the job requisition, receiving feedback from the interviewers, and so forth.

In one embodiment, the business task may be retrieved from a database, or generated using a business task template. For example, the process of hiring an employee would also be applicable from a sales department of an organization to an information technology (IT) department of the same organization.

The participants module 206 identifies participants of the business task. For example, participants of the business tasks of hiring an employee include an HR personal, a manager, a supervisor, and so forth. The participants may vary depending on the business task. For example, the business task of generating a purchase order may involve personal from the accounting and engineering department. The business task of fulfilling a sales order may involve personal from the sales and accounts receivable department. As such, the participants module 206 identifies the participants based on the business task. In another embodiments, the identification of the participants is updated based on a status or process in the business task. For example, a supervisor may not be identified as a participant once the candidate has been hired. A new participant in the business process would include an HR benefits coordinator at that stage in the process of the business task.

The communications module 208 tracks communications among participants related to the business task. For example, emails, chats, and instant messages that are related to the business task may be filtered and used by the collaboration cloud application 110. The communications module 208 may interface with common email servers or clients, or instant messages applications. The communications module 208 may allow a participant to communicate within the user interface to other participants. In other words, the communications module 208 allows a participant to send and receive communications related to the business task. In another embodiment, the communications module 208 enables a participant to invite or remove other participants. A status for an object or document may also be set using the communications module 208. In yet another embodiment, the communications module 208 may interface with a calendar or another third-party communication application.

The objects module 210 identifies documents and objects associated with the business task. For example, documents associated with the business task may include written documents, websites links, documents related to the business task, spreadsheets related to the business task, PDF documents, and so forth. The documents may also include multimedia documents such as module and/or video. The objects may include drawings, shortcuts to applications relevant to the business task, and multimedia objects. For example, when a user clicks on a document, the corresponding application opens up the document.

In another embodiment, objects may be dragged and dropped into and out of an object and document area. Objects may be grouped together based on their functionalities or commonalities. For example, spreadsheets may be grouped together. Objects may also be filtered with a switchable filter according to an object type.

The user interface module 212 generates a collaborative display for the business task for the participants to collaborate on the business task. The collaborative display identifies the participants of the business task, the process of the business task, the communications among participants related to the business task, and the documents and objects associated with the business task. The collaborative display may also be referred to as the user interface. Examples of the user interface are illustrated and described further below.

FIG. 3 is a block diagram illustrating an example embodiment of a user interface 300 of the collaboration cloud application. The user interface 300 includes, for example, a title section 302, a filter content section 304, a participant section 306, a communication section 308, a process status section 310, and a virtual zoomable area for objects and documents.

The title section 302 identifies a name of the business task. For example, the name of the business task may be “Hire an HTML 5 Developer.” The filter content section 304 allows a user of the collaboration cloud application to filter out content in the canvas or working area (objects and documents area) based on a user-specified criteria.

The participant section 306 identifies the names of all participants associated with the business task named in title section 302. In another embodiment, the participant section 306 is updated to identify the name of participants based on an updated status of the process of the business task.

The communication section 308 provides a means for a participant to communicate with other participants of the business task. For example, the communication section 308 may provide a chat window or an e-mail window or a feed window to enable communication with other participants of the business task. In one embodiment, the communication section 308 may include an instant messaging interface for communication with the other participants of the business task. In another embodiment, the communication section 308 retrieves e-mails from a participant's e-mail account where the e-mails are relevant and related to the business task soul asked to provide a consolidated user interface for activities related the business task.

The process status section 310 displays the process of the business task. For example, steps to achieve the business task are listed. In one embodiment, each step is associated with identified participants. The process status section 310 may also indicate which steps have been completed, and which steps still need to be completed. In another embodiment, the process status section 310 may also display the process on a timeline.

The virtual zoomable area for objects and documents 312 provide a container area for documents and objects to be placed. The objects and documents may be associated with each step of the process of the business task. For example, a document may be generated based on the status of a step of the process of the business task. In the example of hiring an employee, feedback from interviewers may be collected and aggregated in a single spreadsheet document that is accessible in the virtual zoomable area 312.

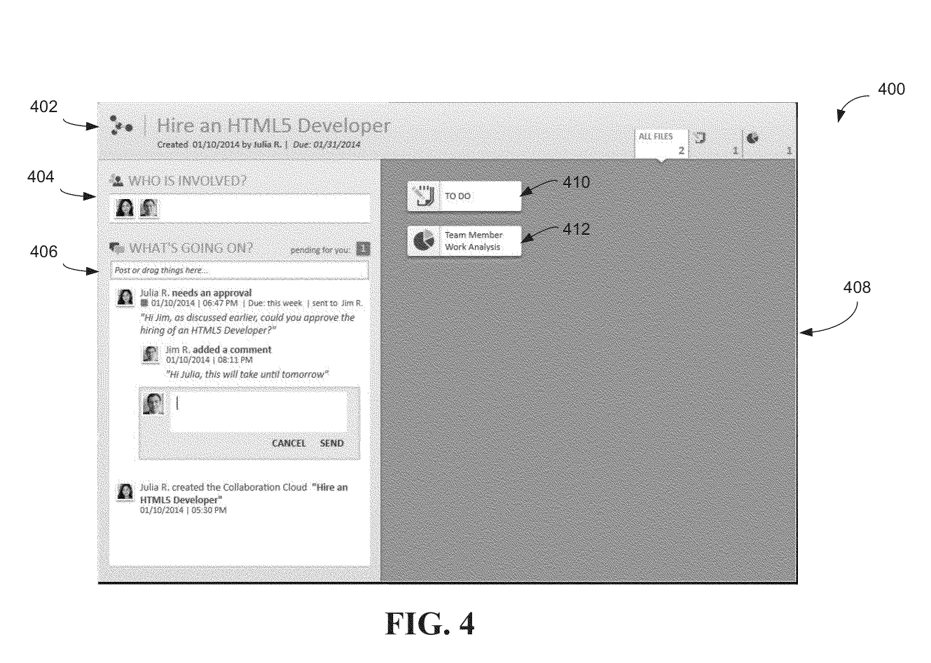

FIG. 4 is a block diagram illustrating another example embodiment of a user interface 400 of the collaboration cloud application. The title section 402 relates to the present business task of hiring an HTML 5 developer. A participant section 404 illustrates who is involved with the business task titled in section 402. In one embodiment, thumbnail pictures of participants may be displayed. A communication section 406 illustrates communications between participants in a chat format. An area for objects and documents 408 includes a to-do list 410, and a team member work, and analysis document 412.

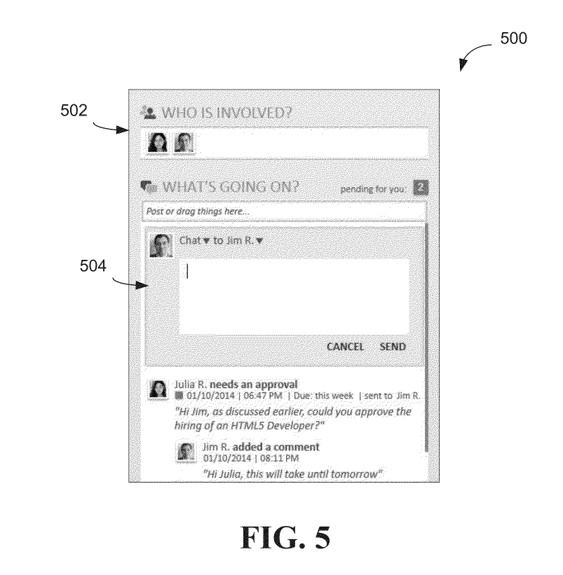

FIG. 5 is a block diagram illustrating another example embodiment of a user interface 500 of participants identification area 502 and a communication area 504 of the collaboration cloud application. The communication area 504 provides a selectable chat function from a participant to another participant. In another embodiment, the participant may be able to communicate with a user outside the participants identified in identification area 502.

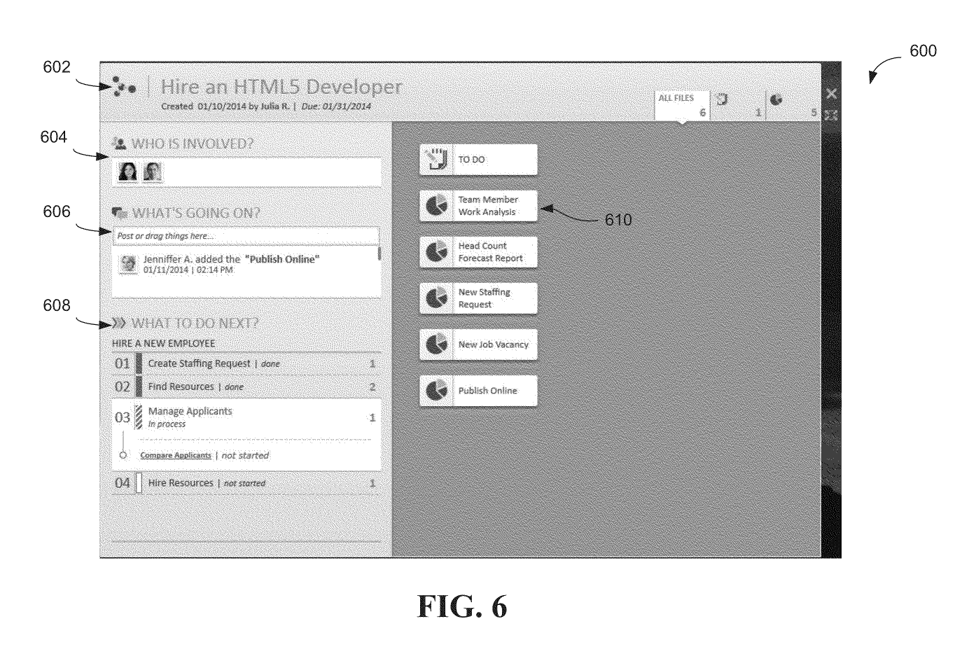

FIG. 6 is a block diagram illustrating another example embodiment of a business process area of a user interface 600 of the collaboration cloud application. The user interface 600 includes a title section 602, a participant section 604, a communication section 606, a process status section 608, and a documents and objects area 610. The communication section 606 illustrates activities performed by other participants with respect to the business task. For example, a document has been added to the documents and objects area 610.

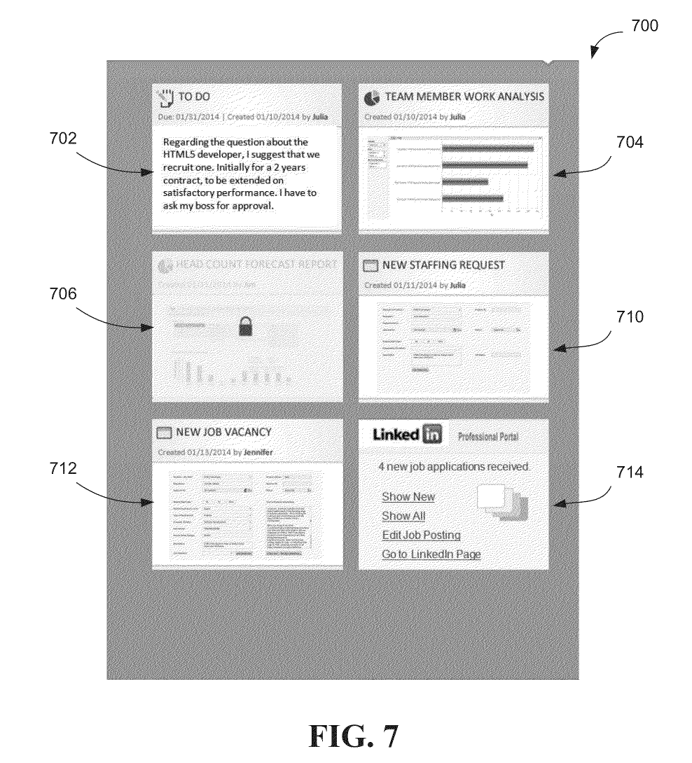

FIG. 7 is a block diagram illustrating another example embodiment of an object area 700 of a user interface of the collaboration cloud application. The object area 700 includes a to do note 702, a team member work analysis spreadsheet document 704, a password-protected document 706, a new staffing request spreadsheet 710, a new job vacancy specification document 712, and a website link 714.

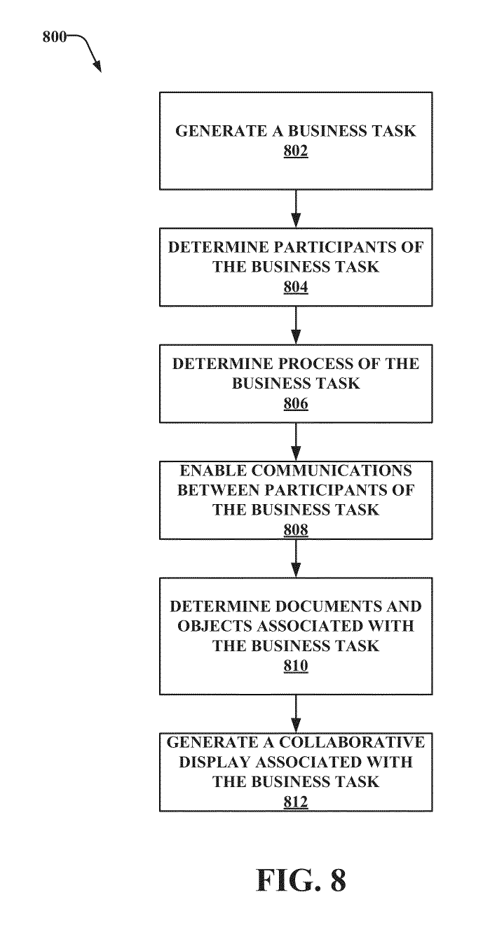

FIG. 8 is a flowchart 800 of a method, in accordance with an example embodiment, for generating a collaborative user interface of a business process. At operation 802, a business task is generated. In one embodiment, the business task module 202 generates the business task.

At operation 804, participants of the business task are determined. In one embodiment, the participants module 206 identifies participants associated with the business task.

At operation 806, a process of the business task is determined. In one embodiment, the process module 204 identifies the process or steps required to accomplish the business task.

At operation 808, communications between participants of the business task are enabled. In one embodiment, the communications module 208 enables participants to communicate with each other.

At operation 810, documents and objects associated with the business task are determined. In one embodiment, the objects module 210 generates a display of documents and objects associated with the business task in the user interface.

At operation 812, a collaborative display associated with the business task is generated. In one embodiment, the user interface module 212 generates the collaborative display.

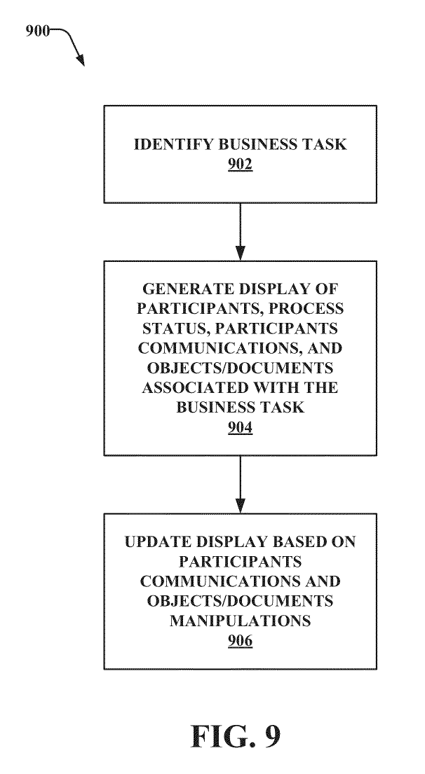

FIG. 9 is a flowchart 900 of a method, in accordance with an example embodiment, for making use of a collaborative user interface of a business process.

At operation 902, a business task is identified. At operation 904, a display of an identification of participants, the process status, participants' communications, and objects and documents associated with the business task is generated. At operation 906, the display is updated based on participants' communication and objects/documents manipulations by the participants.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

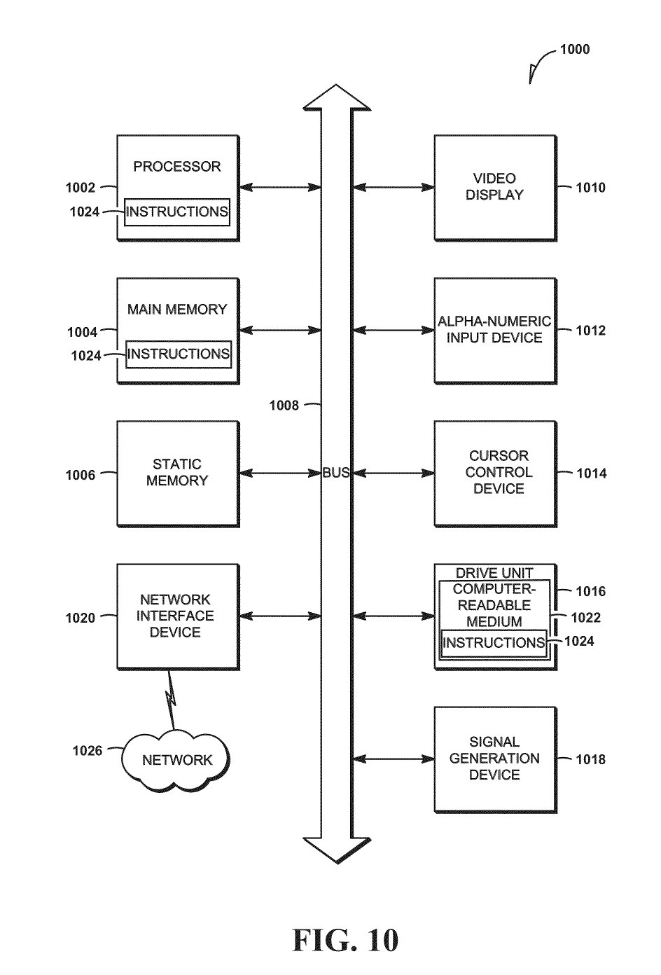

With reference to FIG. 10, an example embodiment extends to a machine in the example form of a computer system 1000 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 may include a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). In example embodiments, the computer system 1000 also includes one or more of an alpha-numeric input device 1012 (e.g., a keyboard), a user interface (UI) navigation device or cursor control device 1014 (e.g., a mouse), a disk drive unit 1016, a signal generation device 1018 (e.g., a speaker), and a network interface device 1020.

The disk drive unit 1016 includes a machine-readable storage medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media.

While the machine-readable storage medium 1022 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present description, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present invention.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the example embodiments as represented by the appended claims. The specification and drawings are, accordingly, to be regarded in an illustrative rather than a restrictive sense.

What is claimed is:

1. A computer-implemented method comprising:
generating, using at least one processor, a business task;
determining participants of the business task, a process of the business task, communications among participants, documents and objects associated with the business task; and
generating a collaborative display for the business task for the participants to collaborate on the business task, the collaborative display identifying the participants of the business task, the process of the business task, the communications among participants, the documents and objects associated with the business task.

2. The computer-implemented method of claim 1, further comprising:
updating the collaborative display based on participants identified in the business task, a status of the process of the business task, communications among participants, updated documents and objects associated with the business task.

3. The computer-implemented method of claim 1, wherein generating the business task comprises:
determining a template associated with the business task; and
generating the process of the business task based on the template.

4. The computer-implemented method of claim 1, wherein generating the collaborative display further comprises:
generating a user interface having a first section to identify the business task, a second section to identify participants of the business task, a third section to display communications between participants of the business task, a fourth section to provide the process of the business task, and a fifth section to provide documents and objects associated with the business task.

5. The computer-implemented method of claim 4, wherein generating the user interface further comprises:
filtering messages associated with the business task from an inbox email of a participant; and
integrating the filtered messages and other communications related to the business task in the third section of the user interface.

6. The computer-implemented method of claim 4, wherein generating the user interface further comprises:
displaying a status of the process of the business task in the fourth section of the user interface;
displaying completed steps of the process of the business task in the fourth section of the user interface;
displaying remaining steps of the process of the business task in the fourth section of the user interface; and
displaying participants associated with the status, the completed steps and the remaining steps of the process of the business task in the fourth section of the user interface.

7. The computer-implemented method of claim 4, wherein generating the user interface further comprises:
displaying a thumbnail view of the objects and documents associated with the business task in the fifth section based on a status of the process of the business task, wherein each thumbnail view of each object or document is associated with a corresponding application.

8. The computer-implemented method of claim 7, wherein the objects comprise a document, an image, an application, a contact, a meeting schedule, a web site, or a note.

9. A system comprising:
a processor comprising a business task module, a process module, a participants module, a communications module, an objects module, and a user interface module,
the business task module configured to generate a business task,
the process module configured to determine a process of the business task,
the participants module configured to identifying participants of the business task,
the communications module configured to track communications among participants related to the business task;
the objects module configured to identify documents and objects associated with the business task, and
the user interface module configured to generate a collaborative display for the business task for the participants to collaborate on the business task, the collaborative display identifying the participants of the business task, the process of the business task, the communications among participants related to the business task, and the documents and objects associated with the business task.

10. The system of claim 9, wherein the user interface module is configured to update the collaborative display based on participants identified in the business task, a status of the process of the business task, communications among participants, updated documents and objects associated with the business task.

11. The system of claim 9, wherein the business task module is configured to determine a template associated with the business task, and to generate the process of the business task based on the template.

12. The system of claim 9, wherein the user interface module is configured to generate a user interface having a first section to identify the business task, a second section to identify participants of the business task, a third section to display communications between participants of the business task, a fourth section to provide the process of the business task, and a fifth section to provide documents and objects associated with the business task.

13. The system of claim 9, wherein the user interface module is configured to filter messages associated with the business task from an inbox email of a participant, and to integrate the filtered messages and other communications related to the business task in the third section of the user interface.

14. The system of claim 13, wherein the user interface module is configured to display a status of the process of the business task in the fourth section of the user interface, display completed steps of the process of the business task in the fourth section of the user interface, display remaining steps of the process of the business task in the fourth section of the user interface, and display participants associated with the status, the completed steps, and the remaining steps of the process of the business task in the fourth section of the user interface.

15. The system of claim 13, wherein the user interface module is configured to display a thumbnail view of the objects and documents associated with the business task in the fifth section based on a status of the process of the business task, wherein each thumbnail view of each object or document is associated with a corresponding application.

16. The system of claim 9, wherein the objects comprise a document, an image, an application, a contact, a meeting schedule, a web site, or a note.

17. A non-transitory machine-readable storage medium storing instructions which, when executed by at least one processor, performs operations comprising:
generating a business task;
determining participants of the business task, a process of the business task, communications among participants, documents and objects associated with the business task;
generating a collaborative display for the business task for the participants to collaborate on the business task, the collaborative display identifying the participants of the business task, the process of the business task, the communications among participants, the documents and objects associated with the business task; and
updating the collaborative display based on participants identified in the business task, a status of the process of the business task, communications among participants, updated documents and objects associated with the business task.

18. The non-transitory machine-readable storage medium of claim 17, wherein generating the business task comprises:
determining a template associated with the business task; and
generating the process of the business task based on the template.

19. The non-transitory machine-readable storage medium of claim 18, wherein generating the collaborative display further comprises:
generating a user interface having a first section to identify the business task, a second section to identify participants of the business task, a third section to display communications between participants of the business task, a fourth section to provide the process of the business task, and a fifth section to provide documents and objects associated with the business task.

20. The non-transitory machine-readable storage medium of claim 19, wherein generating the user interface further comprises:
filtering messages associated with the business task from an inbox email of a participant;
integrating the filtered messages and other communications related to the business task in the third section of the user interface;
displaying a status of the process of the business task in the fourth section of the user interface;
displaying completed steps of the process of the business task in the fourth section of the user interface;
displaying remaining steps of the process of the business task in the fourth section of the user interface;
displaying participants associated with the status, the completed steps and the remaining steps of the process of the business task in the fourth section of the user interface; and
displaying a thumbnail view of the objects and documents associated with the business task in the fifth section based on a status of the process of the business task, wherein each thumbnail view of each object or document is associated with a corresponding application.
